(19) United States
(12) Patent Application Publication
(10) Pub. No.: US 2025/0002383 A1
(43) Pub. Date: Jan. 2, 2025

(54) NANO BUBBLE AND HYDROXYL RADICAL GENERATOR (NBHRG) AND PROCESSING SYSTEM TO DECONTAMINATE WATER WITHOUT CHEMICALS USING NBHRG

(71) Applicant: NABAS Group, Inc., Rockville, MD (US)

(72) Inventor: Dong Sik KIM, Inchon City (KR)

(21) Appl. No.: 18/414,308

(22) Filed: Jan. 16, 2024

Related U.S. Application Data
(63) Continuation of application No. 14/890,103, filed on Jan. 17, 2018, now Pat. No. 11,873,239.
(60) Provisional application No. 62/247,319, filed on Oct. 28, 2015.

(30) Foreign Application Priority Data
Apr. 6, 2015 (KR) 10-2015-0048615

(51) Int. Cl. C02F 1/78; B01F 23/23; B01F 23/232; B01F 23/233; B01F 23/237; B01F 23/2373; B01F 25/312; B01F 25/51; B01F 25/52; B01F 25/53; B01F 27/272; B01F 33/81; C02F 1/74; C02F 7/00

(52) U.S. Cl. CPC C02F 1/78; B01F 23/23; B01F 23/2323; B01F 23/233; B01F 23/2373; B01F 25/3121; B01F 25/51; B01F 25/52; B01F 25/53; B01F 27/2721; B01F 27/2722; B01F 33/811; C02F 1/74; C02F 7/00; B01F 23/237611; B01F 23/237612; B01F 23/237613; C02F 2201/002; C02F 2201/782; C02F 2305/023; Y02W 10/37

(57) ABSTRACT

[Summary]

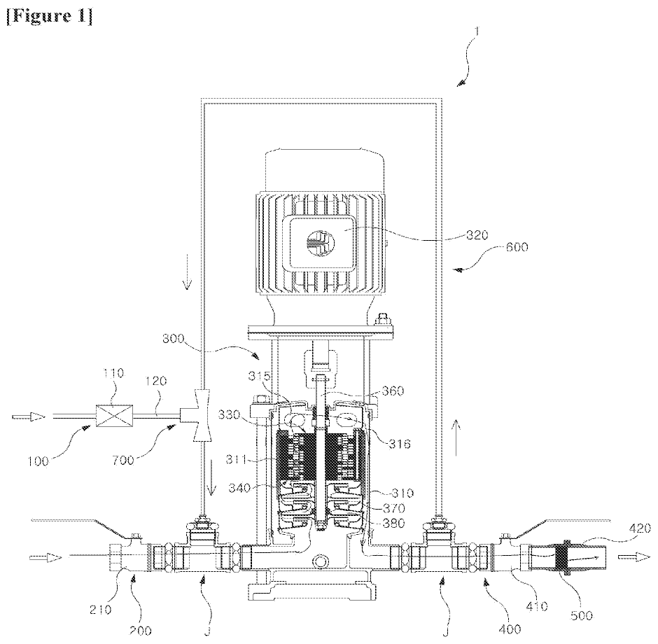

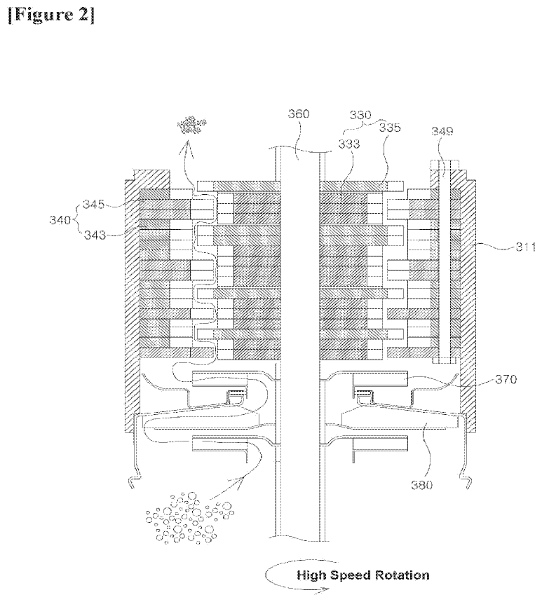

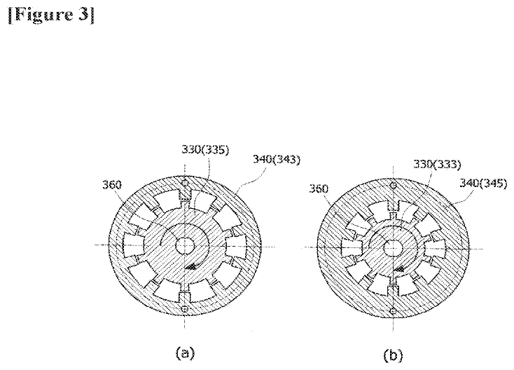

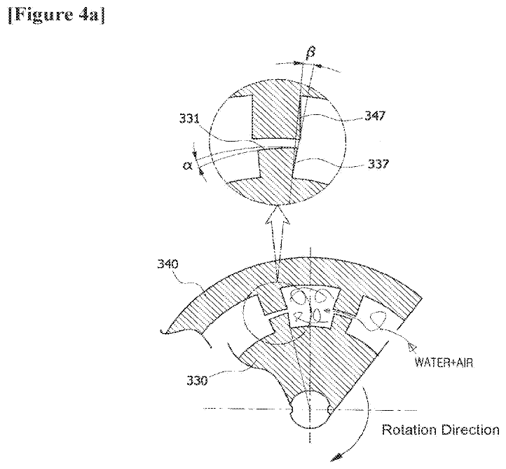

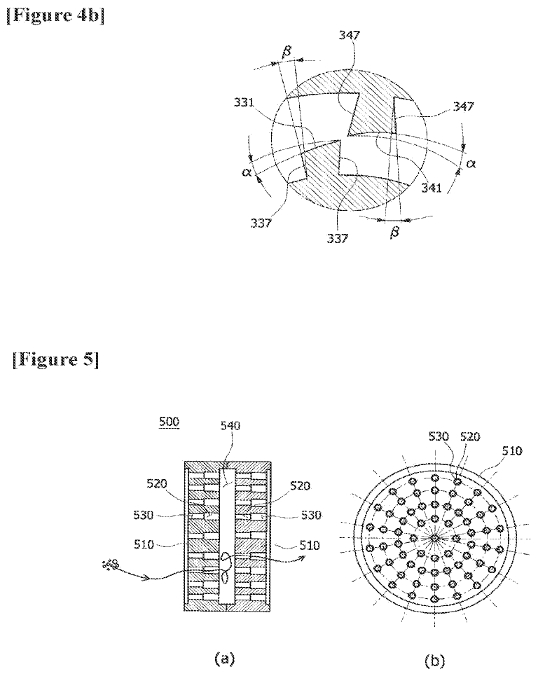

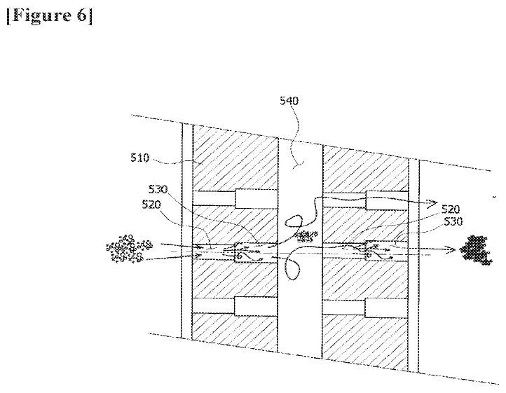

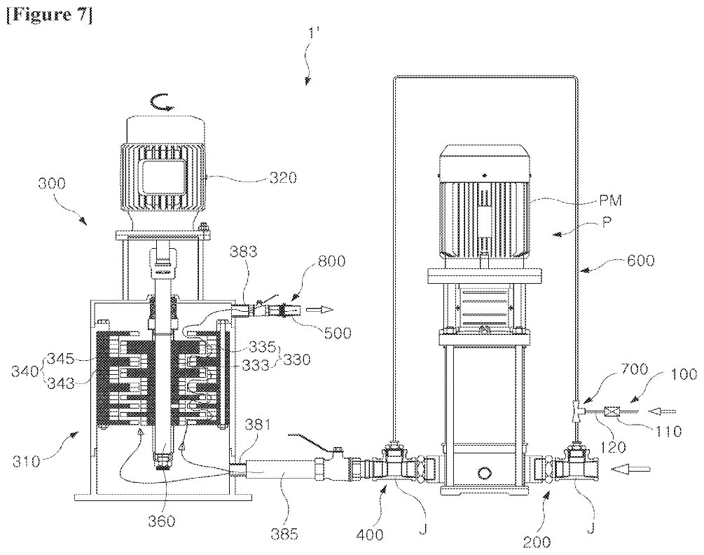

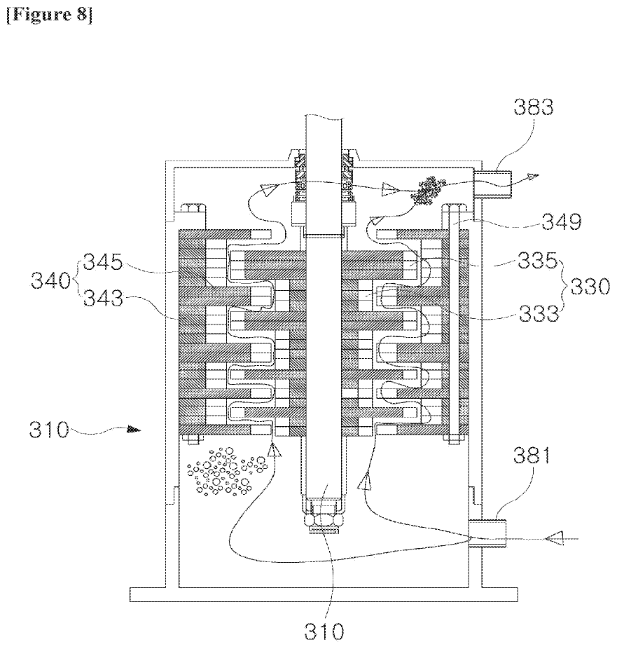

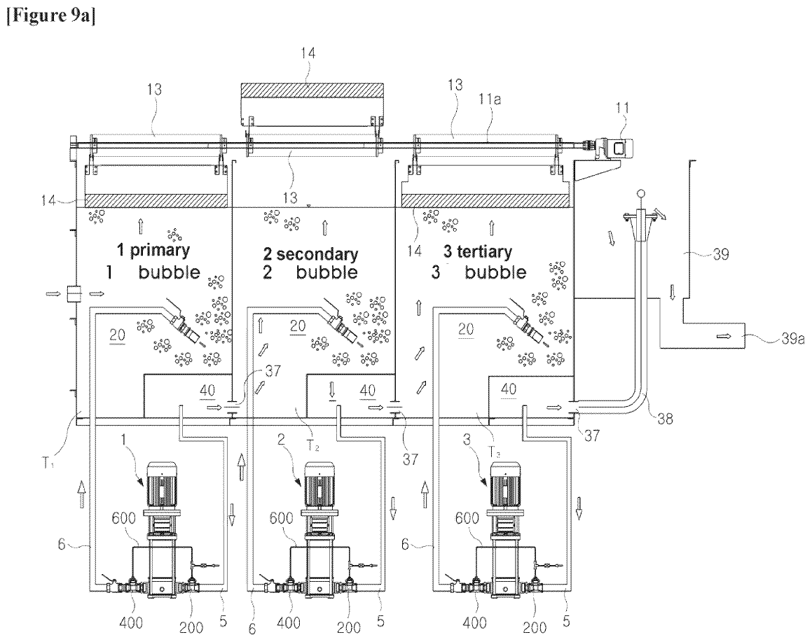

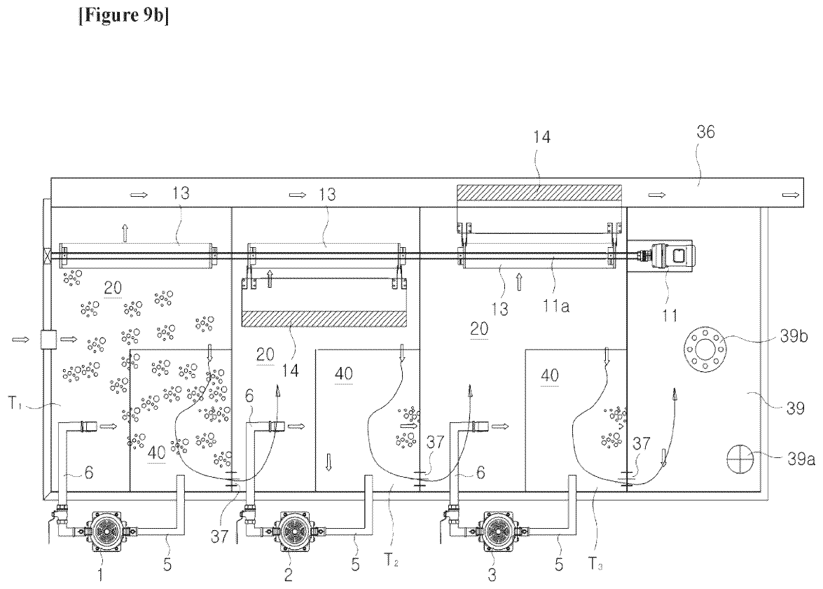

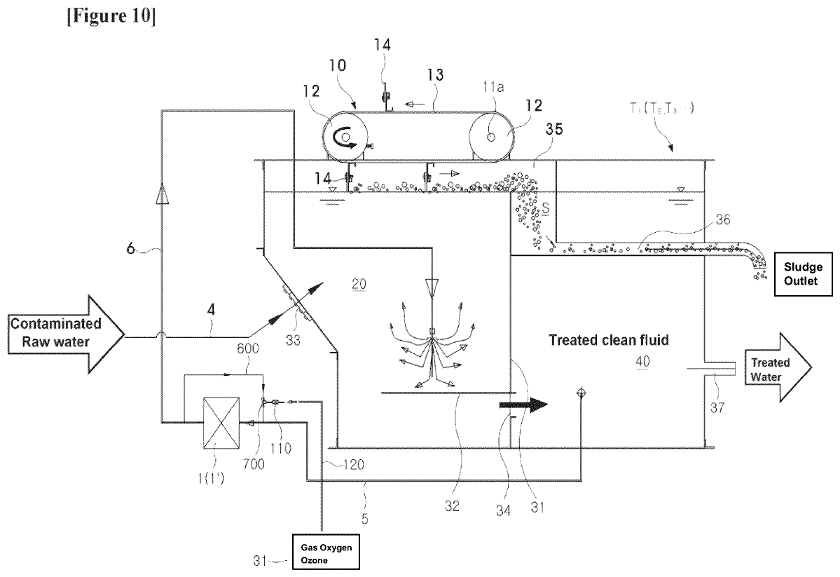

This invention is about Nano Bubble and Hydroxyl Radical Generator and has the following detail features;
Air inlet part;
Inlet pipe for inflowing liquid connected to the above air inlet part;
Pump connected to the above inlet pipe;
Drive motor connected to the above pump;
Rotating blade connected to drive axis of the above drive motor;
Fixed blade connected to inside wall of the above pump, and arranged between the above rotating blade;
The above rotating blade, the fixed blade or cylindrical blade surfaces of both blades are slanted in a direction.

Therefore, this invention proposes Nano Bubble and Hydroxyl Radical Generator which increases dissolving rate of gas by accelerating finization and mix of air and liquid through inducing turbulence of air and liquid by way of constructing slant on surfaces of each blade.

### DETAILED DESCRIPTION

### Technical Aspect

This invention is to generate nano bubble and hydroxyl radical through finezation and mix of air and liquid, and about a generator of nano bubble and hydroxyl radical which can increase the amount of gases such as oxygen and ozone dissolved in water, and about a processing system to decontaminate water without chemicals using the above generator.

### Background Technology of the Invention

The growth of algae and water plants in small lakes and water hazards in golf courses depends on sunlight, water, and inorganic nutrients such as nitrogen and phosphorus, which are supplied by rain and irrigation water.

If inorganic nutrients continuously flow into a lake and a water hazard, eutrophication gets worse because of over-growth of algae and water plants, which in turn causes algal bloom.

If algal bloom is not treated, algae and water plants die due to the decreased amounts of dissolved oxygen in water. Then the dead algae and water plants are decomposed by aerobic microorganisms.

When water is stagnant, the amount of dissolved oxygen further decreases as decomposition by aerobic microorganisms progresses. If it reaches anaerobic state of no or significant lack of oxygen, a pond gives out bad odor from hydrogen sulfide or methane, which are produced by anaerobic microorganisms.

The most widely used method to improve water quality of small lakes and streams is aeration by blower and air diffuser installed in deep water to increase amounts of dissolved oxygen, which in turn increases metabolism of aerobic microorganisms. But this method does not effectively utilize air diffuser and not supply enough oxygen to water. So it does not improve water quality compared to the cost of investment for equipments.

Especially it is not effective in summer when green algae prospers to contaminate and give out bad odor.

In addition, water in small lakes and water hazards in golf courses, which are used as obstacles along with landscapes, decomposes rather quickly because their floors are made of concrete or treated for water-proof in order to reduce the loss of water to underground and prevent flow of water into golf fields.

Furthermore, the quality of water is more deteriorated by inflow of pesticide residues which are used to maintain grasses of fields and greens because excessive amount of pesticides are often used.

Fountains and special enzymes are often used to prevent decomposition of pond. But fountains are not effective to purify water because what they do is only circulation of water. Special enzymes may effectively remove contaminants, but the cost is very high.

A solution for the above problems is Korea Publicized Patent #10-2007-0062060, wherein planting bag for submerged plants and mesh bag of charcoal are connected into one piece.

But it is impossible for this method to purify all water hazards in a golf course and effective only in limited area.

In addition, it is difficult to manage equipments because this method needs various kinds of planting bags to improve water quality. And the planting bags have to be replaced and maintained periodically. So it is laborious to manage equipments and the cost of maintenance is high.

And the current Dissolved Air Flotation (DAF) system in a Terminal Disposal Plant of Sewage uses a pump for water supply, a compressor for air supply, and pressure tank to produce micro bubble.

But DAF system is not energy efficient, and needs accessory equipments such as air compressor and pressure tank, and requires a large area for the facility. So it is not cost effective.

### PRECEDENT TECHNOLOGY REFERENCE

### Patent Reference

(Patent Reference 1) Publicized Patent of Republic of Korea #10-2007-0062060 (Jun. 15, 2007)

### CONTENTS OF INVENTION

### Problems to Solve

This invention has been developed to solve the above problems and has following purposes:

First, this invention provides Nano Bubble and Hydroxyl Radical Generator (NBHRG) which increases the amount of dissolved oxygen in a liquid by accelerating finezation and blend of air and liquid by inducing turbulence of air and liquid through giving slope to cylindrical surface of each blade in pump.

Secondly, this invention accelerates turbulence of air and liquid by introducing eddy booster that is constructed by giving slopes to sides of rotating blades and fixed blades.

Thirdly, this invention produces nano bubble and hydroxyl radical more effectively by lengthening water path through proper arrangement of rotating and fixed blades, or by controlling the amount of water hit by blades.

Fourthly, this invention maximizes cavitation effect through pressure change of discharged liquid by introducing bulkhead in outlet pipe of the pump.

Fifthly, through the above characteristics this invention decontaminates water at low cost by providing the purifying system of contaminated water without chemicals using NBHRG, which has great economic ripple effects by reducing energy consumption of DAF system in terminal disposal plant of sewage and decreasing number of equipments and area for facility, and at the same time it prevents secondary pollution by chemicals such as coagulant polymers

### Method to Solve Problems

The nano bubble and hydroxyl radical generator (NBHRG) in this invention has following features:
Pump that liquid can flow in and out;
Drive motor connected to a shaft of the pump;
Rotating blades that are installed in the drive motor and constructed with laminated large teeth and small teeth;
Fixed blades that is installed in inside wall of the pump and constructed with laminated large teeth and small teeth combined to large teeth and small diameter teeth of the rotating blades at a certain distance;
Double impellers that are installed in the rotation axis of the drive motor, and placed in the entrance of the pump and before the rotating blade and fixed blade;
Double chambers placed between impellers to pass liquid which is transported by rotation of impellers;
Air inlet that supplies at least one gas among air, oxygen and ozone to the pump inlet;
Recirculation pipe that resupplies liquid flowing from the pump outlet to the inlet by connecting inlet and outlet of the pump. The air inlet is connected to the recirculation pipe. The connection part of air inlet and liquid recirculation pipe is a venturi tube that has bottleneck part and expansion part.

The rotating blade of NBHRG in this invention has a feature that the slope of cylindrical surface of the blade includes the first slope that is formed against rotating direction of the blade

The fixed blade of NBHRG in this invention has a feature that the slope of cylindrical surface of the blade includes the second slope that is formed against the first slope of the rotating blade.

The rotating blade, fixed blade, and the blade sides of the rotating blade and fixed blade of NBHRG in this invention have a feature of eddy booster that is slanted against radius line.

The rotating blade in this invention is comprised of several the first small teeth arranged in layer at rotation axis of the drive motor, and several the first large teeth placed between the first small teeth.

The fixed blade in this invention is comprised of several the second small teeth fixed at inside wall of the pump and arranged in layer corresponding to the first large teeth of the rotating blade, and the second large teeth corresponding to the first small teeth of the rotating blade.

Each large teeth in this invention has features that it is placed between each small teeth of the rotating blade and the fixed blade, and arranged in single or double layers, and has more number of layers at liquid outlet than inlet.

The outlet pipe in this invention has a feature of bulkhead to accelerate production of nano bubble by inducing pressure change in discharged liquid.

The bulkhead part in this invention is comprised of a bulkhead placed in the outlet pipe, several small diameter partitions comprised at the bulkhead, and expanded large partition that is connected to small diameter partition.

The bulkhead in this invention is comprised of double bulkheads that are separated to form hollow space.

This invention provides processing system to decontaminate water without chemicals using the above NBHRG. This system has following features:
More than one water tank of certain width and length are connected and arranged in a row;
The water tank is divided by partitions that have holes to transport or discharge processed liquid;
The water tank is divided by processing room for inflowing water and storage room for processed water;
A transfer pipe and a collection pipe, that are connected to the outlet and the inlet of the pump are, installed in the processing room for inflowing liquid and the storage room for processed liquid;
At the processing room of the front-line water tank a pipe is connected through original liquid inlet to supply original contaminated water;
The processing room for inflowing liquid and the storage room for processed liquid are constructed in a way that processed liquid can flow from the processing room to the storage room through holes in partition that divides the two rooms.
The processing room and the storage room are constructed in a way that at least a portion of processed liquid in the storage room can be supplied to the processing room through the NBHRG;
A stopping plate, where nano bubbles collide at certain place between the above holes in the partition and the end of transfer pipe, is placed in the processing room;
A conveyor that has double transfer plates, that filter out sludge and contaminants in original contaminated water or inflowing water, is installed at the upper portion of the processing room.

### Effects of Invention

NBHRG in this invention increases dissolved oxygen by accelerating finezation and blend of air and liquid by inducing turbulence of air and liquid through slopes of cylindrical surfaces of each blade in pump.

This invention maximizes the amount of dissolved oxygen in liquid and produces hydroxyl radical by accelerating turbulence of air and liquid by introducing eddy booster that is constructed by giving slopes to sides of rotating blades and fixed blades)

This invention increases reliability of the equipment by producing nano bubble and hydroxyl radical more effectively by lengthening water path through proper arrangement of rotating blade and fixed blade, or by controlling the amount of water hit by blades.

This invention introduces bulkhead part in outlet pipe, and induces pressure change of discharged liquid that passes through the bulkhead. To induce pressure change the bulkhead part is comprised of small diameter partitions at bulkhead and expanded large diameter partition that leads to small diameter partition. And hollow space is formed by two separated bulkheads so that cavitation effect is maximized as discharged liquid pass through bulkhead, hollow space, and another bulkhead sequentially.

This invention produces more perfect air bubbles by introducing recirculation pipe in order to recycle liquid flowing from the outlet to the inlet.

This invention installs venturi pipe at recirculation pipe which is effective to reduce energy consumption by intaking air without electric power using pressure difference of recirculation liquid that passes through venturi pipe that is connected to air inlet. So it increases cost effectiveness because it does not need separate installation for forceful air intake.

This invention improves cost effectiveness greatly by decreasing energy consumption of bubble generator pump of pressure flotation equipment in a Terminal Disposal Plant of Sewage by fifty percent, and cutting cost by reducing number of equipments and area for facility because it does not need compressor for air intake and equipment for pressure tank.

### BRIEF EXPLANATION OF DIAGRAMS

Diagram 1 is the first implementation example of NBHRG of this invention.

Diagram 2 is pump part of Diagram 1 and expanded cross-sectional drawing of flow of liquid in NBHRG.

Diagram 3 is cross-sectional drawing of joined state of rotating blade and fixed blade of the pump in Diagram 2.

Diagram 4 is cross-sectional drawing of blade angle of each blade in Diagram 3 comprised in different forms.

Diagram 5 is drawing of (a) longitudinal section and (b) cross-section of bulkhead located at outlet pipe side in Diagram 1.

Diagram 6 is a drawing of liquid flow passing through bulkhead in Diagram 5.

Diagram 7 the second implementation example of NBHRG of this invention.

Diagram 8 is pump part of Diagram 7 and expanded cross-sectional drawing of flow of liquid in NBHRG.

Diagram 9 is (a) front view and (b) sectional plane of processing system to decontaminated water without chemicals in this invention by separating solid from liquid without compressor for air intake and pressure tank of DAF system in a Terminal Disposal Plant of Sewage using NBHRG of Diagram 1.

Diagram 10 is a sketch of water tanks of processing system to decontaminate water without chemicals (Diagram 9) that does not have compressor for air intake and pressure tank of DAF system used in a current Terminal Disposal Plant of Sewage, especially illustrating organization of the first water tank,

### DETAILS TO IMPLEMENT INVENTION

Details of NBHRG of this invention will be explained in following while referring to diagrams.

The NBHRG of this invention can be used to improve water quality by increasing supply of dissolved oxygen to small lakes and water hazards in golf courses, other reservoirs, contaminated water treatment plants, fish tanks, and fish farms by producing nano bubbles and hydroxyl radicals through selective finezation and mix of liquid and gases (previously stated as “air”) such as air, oxygen, and ozone. The NBHRG of this invention can be used for food sterilization, deodorization, washing system, and skin care. For reference, hydroxyl (OH) radical is an oxygen anionic matter produced in plasma state. It is a radical of hydroxyl anion (OH) and is powerful in sterilization, disinfection, deodorization and decomposition due to its strong oxidizing power, but is not harmful to human body because it is reduced to oxygen and water after reacting with contaminants. Its sterilizing rate is 2000 times faster than ozone and 180 times faster than UV. And it reacts with almost all of contaminants in air and water so that it deodorizes and decomposes.

Diagrams 1 to 6 show the first implementation example of NBHRG of this invention. Basically the NBHRG (1) has following installations:
A pump that has built-in double impellers (370) and blades (330, 340);
A drive motor (320), which is installed at a side of the pump, for impellers (370) and blades (330, 340);
An inlet pipe (200) that is connected to inlet part of the pump (300) to supply various kinds of contaminated waters and circulating liquids such as processed water;
An outlet pipe (400) connected to outlet part of the pump (300) corresponding to the inlet pipe;
An air inlet (100) installed at inlet part of the pump (300) to supply gases such as air, ozone (O₃), oxygen, hydrogen, and nitrogen extracted from air from outside of the pump to inside;
A recirculation pipe (600) to resupply discharged liquid from the outlet pipe (400) to the inlet part of the pump by connecting inlet pipe (200) to outlet (400) pipe.

Air intake part (100) may be directly connected to the inlet pipe (200), but is connected to a side of the recirculation pipe (600) entering into the inlet pipe (200) as in Diagram 1 so that gases such as outside air, oxygen and ozone can be selectively mixed with contaminated liquid and processed liquid that are supplied through the inlet pipe (200).

For which, although not seen in the Diagram, the air intake part (100) can selectively include an oxygen generator that produces oxygen from outside air, an ozone generator that produces ozone by combining oxygen from oxygen generator with outside air, or a prescribed means of air intake to supply gases such as hydrogen or nitrogen selectively. And the air intake part (100) may have a flow rate controller in the middle of air intake pipe (120) to control flow rate of gases such as air, oxygen, or ozone when they enter into recirculation pipe (600) or the inlet pipe (200) through air intake pipe (120).

The recirculation pipe (600) is installed to actualize more perfect mix and finization of liquid by recycling previously mixed and refined liquid in the pump (300) to inside of the pump (300) once more.

For more perfect mix and refinement the recirculation pipe (600) is connected to each joint (J) of the inlet pipe (200) and the outlet pipe (400) of the pump so that at least a portion of discharged liquid from the outlet pipe (400) can be recycled by bringing it back to the inlet pipe (200).

Meanwhile the joining part of the air intake pipe (120) and the recirculation pipe (600) is connected by venturi tube in shape of cross valve (700). Gases such as air, oxygen, and ozone supplied through the air intake pipe (120) are mixed with discharged liquid transported through the recirculation pipe (600) when they pass through bottleneck portion of the venturi tube (700). At this time discharged liquid naturally absorbs gases transported through the air intake pipe (120) by sudden drop of the pressure of discharged liquid and great increase of flow rate.

If the venturi tube is introduced as mentioned above, gases such as air, oxygen and ozone flowing through the air intake pipe (120) are smoothly absorbed into and mixed with liquid by sudden changes of pressure and flow rate of the discharged liquid according to Bernoullis Principle. So this system has merit of cost effectiveness such as great decrease of energy consumption because it does not need separate power source for the above process. In addition the recirculation of the discharged liquid through the recirculation pipe (600) can be controlled to be conducted more than once as needed so that reliability of the equipment is strongly consolidated because it produces more perfect nano bubbles.

As stated above the inlet (200) and outlet (400) pipes of the pump are connected to the recirculation pipe (600) with each joint (J) as the center, and the inlet (200) and outlet (400) pipes may have their own on-off valves (210) (410) to control flow rate of supplied and discharged liquids and to open or shut liquid path.

The NBHRG (1) in this invention produces nano bubbles by cavitation which is caused by striking contaminated liquid, processed liquid or gases such as air, oxygen, and ozone, which are supplied by the inlet pipe (200), with multiple blades (330, 340). In order for this the following devices are installed in the pump (300):
Double impeller (370) that are rotated by drive of motor axis (360); blade (340) fixed at the inside wall (311) of pump housing (310); blade that rotates around the motor axis (360) and induces rotation of the fixed blade (340)

It is desirable that the impeller (370) be installed near inlet side of the pump (300), and the rotating blade (330) and the fixed blade (340) are installed upward and after the impeller (370), and the pathway of the liquid and gas from the inlet side of the pump (300). It is more desirable that the impeller (370) and the rotating blade (330) be combined as one on the motor axis (360). It is also desirable that at least more than one chamber (388), through which liquids (contaminated or processed) and outside air or gases such as oxygen and ozone which are transported by rotation of the impeller (370) pass, be arranged between each impeller (370) installed inside of the pump (300).

In this structure of multiple pumps the impeller (370) and the chamber (380) are arranged alternately and repeatedly, where the impeller (370) is rotated by drive of motor axis, and by that rotating power mixed liquid of water, air, oxygen and ozone is forcefully transported from the inlet side of the pump to the blades (330, 340) placed at the top of the impeller. And dissolved rate of gases in water is more increased during this process while mixed liquid of water, air, oxygen, and ozone passes through double impellers (370) and double chambers (380) after the impellers.

Nano bubbles are produced in mixed liquid of water and gases, that was transported to the blades, (330, 340) by interaction, i.e. relative rotation, between the rotating blade and the fixed blade, and then discharged to outlet side of the pump along water path (316) from outlet (315) placed on top of pump housing (310).

The unexplained number ‘349’ shown as an example in Diagram 2 is fixing bolt, which fixates the fixed blade (340) to the inside wall (311) of pump housing (310). The rotating blade (330) and the fixed blade (340) are lamination in several layers with blades of prescribed thickness, and form several small teeth (333) (343) and several large teeth (335) (345), which are protruded between the several small teeth (333) (343) with set length, at corresponding surface of opposite rotating blade and fixed blade. It is desirable that tips of large teeth (335)(345) and small teeth (333)(343) be comprised in form of sharp knife (cc Diagram 3). In addition, only one large teeth (335)(345) of rotating blade (330) and fixed blade (340) is placed at lower part, where liquid is introduced, and double large teeth can be placed in a layer at upper part.

Since mixed liquid, in which nano bubble is not produced yet, is introduced at lower part, the initial nano bubbles, although the amount is little, are produced by striking liquid with only one large teeth. Water and gases mix more smoothly and more refined nano bubbles are produced at upper part, where liquid is discharged, by striking second time with large teeth of lamination blades in several layer.

As seen in Diagram 2 large teeth (335)(345) of rotating blade and fixed blade should be inserted into each other more than 0.5 times of the length of the blade. By installing like this the large teeth (335)(345) of each blade is inserted as deep as possible so that the length of water path is extended. By which contact surface of each blade and liquid is increased so that much more mixed liquid can be hit. This in turn makes it possible for liquid and gas to get mixed and finized more smoothly.

The rotating blade (330) and the fixed blade (340) in the above structure make their large teeth (335)9345) inserted alternately. And it is good that a certain width of gap be created between opposite large teeth (3350(345) and small teeth (343)(333) so that mixed liquid from impeller (370) can pass through (cc Diagram 2 or 4).

In detail, the large teeth (335) of the rotating blade (330) are inserted between the large teeth (345) of the fixed blade (340) while maintaining the above gap for liquid path. In opposite of this, the large teeth (345) of the fixed blade (340) are inserted between the large teeth (335) of the rotating blade (330) while maintaining the above gap for liquid path.

When the motor operates in this structure, the rotating blade (330) installed on motor axis (360) rotates in such a way that the small teeth (333) and the large teeth (335) of the rotating blade (330) rotates between the large teeth (345) and small teeth (343) of the fixed blade (340), respectively so that relative rotation is created between the large (335) (343) and the small (343)(333) teeth of the rotating (330) and the fixed (340) blades.

When the mixed liquid is introduced to the gap between the rotating blade (330) and the fixed blade (340), it splits into fine size while being mixed by relative rotation produced by the large teeth (335)(345) and the small teeth (343)(333). If the rotating blade (330) is rotated at certain high speed, the mixed liquid split into less than 5 μm sized bubbles while being mixed so that dissolved rate in liquid is increased further.

Especially, in NBHRG of this invention cylindrical surface of the rotating blade (330) and/or the fixed blade (340) should be slanted at least one direction for smooth production of nano sized microbubble (seq. “nano bubble”) (cc Diagram 4). In order for this the rotating blade (330) can be comprised of the first slanted part where the slant (a) of cylindrical surface of each blade is formed against rotation direction of the rotating blade (330). In detail, the slant direction of the first slanted part (331) is higher in rotation direction and lower in the opposite side if the rotation direction of the rotating blade (330) is counterclockwise (cc Diagram 4a). In response to this, the second slanted part (341) can be formed selectively in such a way that cylindrical surface of each blade of the fixed blade (340) is formed against the first slanted part (331) of the slant (a) of rotating blade (330), that is, against rotation direction of the rotating blade (330). In this case the second slanted part (341) is formed in such a way that the slant direction is lower at the opposite side of the first slanted part (331) and higher at the other side (cc Diagram 4b).

Therefore, when the rotating blade (330) rotates, the first slanted part (331) approaches to the second slanted part (341) and comes to face each other at upper dead point of each slant. As rotation continues, space between cylindrical surface, which is formed when each blade faces each other, widens. This in turn maximizes cavitation as rapid swirl is formed.

Meanwhile tilt angle of the first slant part (331) and tilt angle of the second slant part (341) are decided considering length and width of cylindrical surface of each blade, and amount and flow rate of mixed liquid. They can be made in same or different angles with consideration of the above factors.

Referring to the drawing of Diagram 4(a), the rotating blade (330) and the fixed blade (340) have eddy boosters (337)(347) to accelerate eddy formation in mixed liquid by slanting a side of each blade against radius line with certain angle (β).

Since the eddy booster (337)(347) is protruded obliquely against flow direction of mixed liquid, disturbance of mixed liquid met with the booster is promoted producing cavitation, which in turn promotes nano bubble production.

In this case, it is desirable that tilt angles of eddy booster (337)(347) in the rotating blade (330) and the fixed blade (340) be the same, but the angles can be varied with consideration of various factors such as size and length of each blade and movement of mixed liquid.

The Diagram is drawn in such a way that eddy booster (337)(347) is formed in either the rotating blade (330) or the fixed blade (340), but it can be formed in both blade. And as seen in Diagram 4(b) eddy booster (337)(347) can be formed on both sides of the rotating blade (330) and the fixed blade (340).

Diagram 1 shows that the discharge pipe (315) is installed at a portion of upper part of the pump inside to discharge mixed liquid including nano bubbles which is produced by interaction between the rotating blade (330) and the fixed blade (340). It also shows that water path (316) is formed at between pump housing (310) and the inside wall (311) in longitudinal direction of the pump in order for liquid from the discharge pipe (315) to be able to flow toward discharge side of the pump (300). The liquid that flows down along the water path is discharged to outside along the discharge pipe (400) while holding nano bubbles.

Meanwhile if the liquid, which is discharged through the discharged pipe (400) installed at discharge side of the pump, can be finized and mixed one more time by pressure change, the dissolved rate in liquid can be increased further. For this as shown in Diagram 1 the bulkhead part (500) is installed inside of the discharge pipe (400). Diagrams 5 and 6 show that the bulkhead part (500) is comprised of small diameter partition (520; SDP) and large diameter partition (530; LDP) expanded and continuously extended from SDP, and of the bulkhead where this construction of the two partitions is arranged in multiple along the flow direction of liquid inside the discharge pipe (400), wherein cavitation is accelerated by further finization through pressure change as the discharged liquid pass through the LDP (500) after it passes through the SDP (520)

In addition, it is desirable that the bulkhead part (500) include a space (540) of a certain size between continuously extended construction of the SDP (520) and the LDP (530). The discharged liquid that passes through this space is further finized and mixed by acceleration of cavitation with sudden drop of pressure. The number of SDP (520) and LDP (530), which are constructed continuously and arranged repeatedly in the bulkhead (500), should be decided to maintain discharge pressure of liquid to be 4 kg/m², where the diameter of SDP (520) is about 1.5 mm and that of LDP (530) about 2 mm.

But, as stated above the discharge pressure and the size of the bulkhead part (500) are decided with consideration of various factors such as output of drive motor and quantity of liquid etc.

Diagram 7 and 8 are the second implementation example of NBHRG of this invention, wherein pressure pump (P) is added to supply pressurized liquid to NBHRG. The pressure pump (P) is connected to the inlet part of NBHRG (1′) which is comprised of the rotating blade (330) and the fixed blade (340) inside the pump as seen in Diagram 1. The pressure pump (P) has impeller as seen in Diagram 1 and chamber (not seen). In pressure pump (P) the inlet pipe (200) and the outlet pipe (400) are connected to the inlet side and the outlet side, respectively. NBHRG (1′) is connected to the outlet pipe of the pressure pump (P) through a medium of a coupling pipe (385).

On-off valve can be installed at the coupling pipe to control liquid supply or to open and shut.

The Pressure pump (P) includes pump motor (PM) and impeller installed at drive axis of the pump motor (PM). The recirculation pipe (600) is connected through the medium of joint (J) to recycle pressurized liquid from outlet pipe (400) of the pressure pump (P) to inlet pipe (200). In this case as shown in Diagram 1 air inlet pipe (120) of air inlet part can be connected, and venturi pipe (700) is connected at where the air inlet pipe (120) and the recirculation pipe (600) meet so that the previously mentioned outcome can be obtained.

From this construction pressurized liquid is supplied from the pressure pump (P) through the coupling pipe (385) at inlet section formed in bottom portion of the pump (33). Gases in liquid are discharged through the outlet (383), which is installed at upper portion of the pump, after they are finized and mixed by pressure striking by each blade. In this case discharge pipe (800) is connected at the outlet (383) and has on-off valve to control liquid quantity or to open and shut. In addition, the previously mentioned bulkhead part (500) can be installed at the discharge pipe (800), wherein the secondary cavitation is promoted as previously mentioned.

Next section is about the Processing System to Decontaminate Water Without Chemicals (PSDWWC) using NBHRG of this invention. This system purifies, on land without any chemicals, various kinds of contaminated water from lakes, streams, homes and factories.

Diagram 9 and 10 show the PSDWWC in this invention for solid-liquid separation using NBHRG of Diagram 1 or 7 without compressor for air intake and pressure tank used in a Terminal Disposal Plant of Sewage. Diagram 9 is (a) front view and (b) plane view of PSDWWC, and Diagram 10 is a sketch of water tanks of PSDWWC of Diagram 9 that does not use compressor for air intake and pressure tank of DAF system used in a current Terminal Disposal Plant of Sewage, especially illustrating organization of the first water tank. According to Diagram 9a and 9b PSDWWC is comprised of several water tanks (T₁, T₂, T₃) which are connected in a row. Each water tank has a certain width and length, and is connected in the direction of width or length.

For example, each water tank (T₁, T₂, T₃) can be connected in the direction of width as shown in Diagram 9 while the inside of a tank is divided by partition wall at regular interval. And outlet hole (37) is constructed in a partition wall so that water processed in a previous tank can move to the next tank.

Each water tank (T₁, T₂, T₃) is divided into processing room for inflowing water (20; PRIW) and storage room for processed water (40; SRPW). A transfer pipe for processed water (6) and collection pipe for processed water (5), which are connected to outlet pipe (400) and inlet pipe (200) of NBHRG (1), are installed in PRIW (20) and SRPW (40) in each water tank, respectively. A spray nozzle can be installed for pressure spray of nano bubbles and pressurized liquid at the end of the transfer pipe for processed water (6) which is installed at PRIW of each water tank.

In case of the first water tank (T₁) a water pipe (4) can be connected through inlet for original water (33) to supply original contaminated water as shown in Diagram 10. Each water tank (T₁, T₂, T₃) is connected through outlet holes (37) formed at partition walls which are installed to divide each tank. The PRIW (20) and the SRPW (40) of each tank are connected to each other through hole (34) formed at wall that divides them. It is desirable that the hole (34) that connects the PRIW (20) and the SRPW (40) should be made, if possible, at the bottom portion of division wall (31). A stopping plate (32) can be installed at certain place between the above hole (34) and the end of the transfer pipe for processed water (6) in the PRIW (20) of each tank. This stopping plate prevents contaminated water or inflowing water unprocessed by high pressure nano bubbles from NBHRG (1) from flowing into next water tank. The spray nozzle at the end of the transfer pipe of processed water (6) should be placed over the stopping plate (32).

A means to remove sludge (10) is installed at the upper portion of the PRIW (20) of each water tank (T₁, T₂, T₃). This means to remove sludge (10) is comprised of conveyor belt or chain (13) whose surface has several transfer plates (14). The conveyor belts (13) of each means to remove sludge (10) cross upper portions of each water tank. And the conveyor belts are moved by sprocket which is turned by driving shaft (11a) extended from the motor (11) so that the transfer plates (14) on the surface of the belt filter sludge or impurities floating over upper portion of original contaminated water or inflowing water in PRIW (20), and then discharge them through outlet channel (35, 36) installed at upper portion of the rear of the PRIW (20).

The following is explanation about the operation of the Processing System to Decontaminate Water Without Chemicals (PSDWWC) in this invention while referring to Diagram 9 and 10. If original contaminated water flows into the first water tank (T₁), through water pipe (4), the first NBHRG (1) draws purified water (processed water) from the SRPW (40) through collection pipe for processed water (5) and produces nano bubbles, which is then supplied to the PRIW (20) of the first water tank (T₁) through transfer pipe for processed water (6). Nano bubbles spouted into the PRIW (20) of the first water tank (T₁) float to the top of processed room after they collide with the stopping plate (32). At this time sludge or impurities in original contaminated water float to top with nano bubbles. Sludge and impurities floating on top of the PRIW (20) are moved to rear by the transfer plates (14) as the means to remove sludge (10) moves. And then the filtered sludge or impurities are discharged to outside through the outlet channel (35, 36) installed at rear upper portion of the PRIW (20).

On the one hand, the processed water, which is transported to the SRPW through the hole (31) formed at division wall (34) after sludge and impurities are removed, moves to the PRIW (20) of the second water tank (T₂) through the outlet holes (37). A portion of it, as mentioned the above, is supplied to the first NBHRG (1) through the collection pipe for processed water (5).

The processed water from the first water tank (T₁), which flowed to the second water tank (T₂), is processed again as was done in the first water tank (T₁) so that additional sludge and impurities float on top of processing room (20) by nano bubbles supplied by the second NBHRG (2), and then moves to the SRPW (40) through the hole (34) at the division wall (34) after filtered by the means to remove sludge (10).

The processed water in the SRPW (40) then moves to the PRIW (20) of the third tank (T₃) and at the same time a portion of it is supplied to the second NBHRG (2) through the collection pipe for processed water (5) and produces nano bubbles.

The processed water from the second water tank (T₂), which flowed to the third water tank (T₃), is processed again as was done in the second water tank (T₂) so that the rest sludge and impurities float on top of processing room (20) by nano bubbles supplied by the third NBHRG (3), and then moves to the SRPW (40) through the hole (34) at the division wall (34) after filtered by the means to remove sludge (10). The processed water in the SRPW (40) is finally discharged to outside and at the same time a portion of it is supplied to the third NBHRG (3) through the collection pipe for processed water (5) and then the process of nano bubble production is repeated.

As explained above PSDWWC of this invention makes sludge and impurities of inflowing original water floated on top of the water tank by nano bubbles discharged with strong pressure from the first through the third NBHRG. Floating sludge and impurities are discharged outside after being transported by the means to remove sludge so that only purified liquid is supplied to the next water tanks (T₂ and T₃) and then finally utilized. Turbidity and heavy metals in the processed liquid are decomposed by nano bubbles and hydroxyl radicals in sludge, and the amount of dissolved oxygen and anions is high so that it helps greatly to restore ecosystem.

In addition, the liquid processed in this invention can be reused because it has sterilizing power. And this invention uses NBHRG to remove contaminants without using current coagulant chemicals so that it prevents secondary pollution by coagulant polymers. And it is cost effective by reducing energy consumption 50% because it does not use pressure tank and air compressor of DAF system in current Terminal Disposal Plant of Sewage.

The above description is focused on limited configuration and aspect of NBHRG in this invention, but it can be modified and changed by the manufacturer. And its modification and change should be included in confines of rights of this invention.

[Explanation of Symbols]

| | |
|---|---|
| P: Pressure pump | |
| PM: Pressure Motor | J: Joint |
| 100: Air inlet part | |
| 110: Control gauge for liquid quantity | 120: Air inlet pipe |
| 200: Inlet pipe | 210: On-off valve |
| 300: Pump | |
| 310: Pump housing | 311: Inside wall |
| 315: Discharge pipe | 320: Drive motor |
| 330: Rotating blade | 331: First slant part |
| 333: First small teeth | 335: First large teeth |
| 337: First eddy booster | 340: Fixed blade |
| 341: Second slant part | 343: Second small teeth |
| 345: Second large teeth | 347: Second eddy booster |
| 349: Fixed bolt | |
| 360: Motor axis (shaft) | 370: Impeller |
| 380: Chamber | 381: Inlet |
| 383: Outlet | 385: Coupling pipe |
| 400: Outlet pipe | |
| 410: On-off valve | 420: Outlet pipe |
| 500: Bulkhead part | |
| 510: Bulkhead | 520: Small diameter partition |
| 530: Large diameter partition | 540: Space |
| 600: Recirculation pipe | 700: Venturi pipe |
| 800: Discharge pipe | |

1-7. (canceled)

8. A Nano Bubble and Hydroxyl Radical Generator (NBHRG), comprising:
a pump accommodating liquid flow in and flow out through a pump inlet coupled to a pump outlet;
a drive motor connected to a side of the pump;
rotating blades installed in the drive motor and constructed with a lamination of several blades of large teeth and small teeth;
fixed blades installed in an inside wall of the pump and constructed with a lamination of several blades of large teeth and small teeth conjoined by insertion at a certain distance corresponding to large teeth and small teeth of the rotating blades;
multiple impellers installed in a rotation axis of the drive motor, and placed at the pump inlet located prior to the rotating blades and fixed blades;
multiple chambers positioned between the multiple impellers to transport liquid through the pump which is propelled by rotation of the multiple impellers;
a gas generator that supplies at least one gas to the pump inlet;
a liquid recirculation pipe that resupplies liquid flowing from the pump outlet to the pump inlet and connects the pump inlet to the pump outlet;
at least one side of cylindrical surfaces of the rotating blades and the fixed blades are slanted,
wherein the slant of cylindrical surface of each of the rotating blade is comprised of a first slanted part in which its surface is slanted against rotation direction of the rotating blade so that it is higher in rotation direction and lower on an opposite side of rotation direction, and
the slant of cylindrical surface of each of the fixed blade is comprised of a second slanted part in which its surface is slanted against the slant direction of cylindrical surface of the rotating blade so that it is relatively lower on the opposite side of the surface of the first slanted part and higher on its other side,
wherein an eddy booster is formed such that the rotating blade, the fixed blade, and the blade sides of both blades are slanted against a reference radius line.

9. The Nano Bubble and Hydroxyl Radical Generator (NBHRG) of claim 8, further comprising:
an air inlet connected to the liquid recirculation pipe, wherein the connection part connects the air inlet and the liquid recirculation pipe using a venturi tube having a bottleneck part and an expansion part.

10. The Nano Bubble and Hydroxyl Radical Generator (NBHRG) of claim 8, wherein the gas generator comprises at least one of an oxygen generator or an ozone generator.

11. The Nano Bubble and Hydroxyl Radical Generator (NBHRG) of claim 8, further comprising:
a bulkhead installed at the outlet of the pump to accelerate production of the nano bubbles by inducing a pressure change in the liquid exiting the outlet;
wherein the bulkhead comprises a bulkhead structure placed in the outlet having multiple small diameter partitions at the bulkhead, and an expanded large partition that is connected to the small diameter partitions.

12. The Nano Bubble and Hydroxyl Radical Generator (NBHRG) of claim 11, further comprising multiple bulkheads separated from each other to form a space there between.

13. The Nano Bubble and Hydroxyl Radical Generator (NBHRG) of claim 10, wherein the generated nano bubbles infused with ozone or oxygen is used to treat water in a water treatment system, and further comprises:
multiple ones of water tanks connected and arranged in a linear row, wherein each water tank is divided by partitions having holes to transport and/or discharge processed water from the each water tank;
wherein each of the water tanks comprises a processing compartment for inflowing water and a storage compartment for processed water; and
a transfer pipe connected to the pump outlet and a collection pipe connected to the pump inlet, wherein the processing compartment receives inflowing water with nano bubbles from the transfer pipe and the collection pipe collects processed water outflowing from the storage compartment;
the processing compartment of a front-line water tank including a pipe is connected through a water inlet to supply original contaminated water to the front-line water tank to flow from one water tank to a next water tank in the row;
wherein the processing compartment for inflowing water and the storage compartment for processed water are constructed so that processed water can flow from the processing compartment to the storage compartment through a hole in the partition that divides the two compartments;
a stopping plate causing produced nano bubbles to collide located between the hole in the partition and the end of the transfer pipe installed in the processing compartment; and
a discharge outlet at a final water tank for discharging treated water from the treatment system.

14. The Nano Bubble and Hydroxyl Radical Generator (NBHRG) of claim 13, further comprising a conveyor possessing multiple transfer plates to filter out sludge and contaminants in original contaminated water or inflowing water, which is installed at the upper portion of the processing compartment for inflowing water.

15. A method for producing nano bubbles with hydroxyl radicals, comprising the steps of:
forcing a liquid flow in and flow out through a pump inlet coupled to a pump outlet of a liquid pump;
mixing the liquid flow with rotating blades comprising the pump constructed with a lamination of several blades of large teeth and small teeth;
installing fixed blades on an interior wall of the pump constructed with a lamination of several blades of large teeth and small teeth conjoined by insertion at a certain distance corresponding to large teeth and small teeth of the rotating blades;
rotating multiple impellers installed in a rotation axis of a drive motor of the pump, and placed at the pump inlet positioned prior to the rotating blades and fixed blades;
positioning multiple chambers between the multiple impellers to transport liquid through the pump and propelled by rotation of the multiple impellers;
supplying at least one gas from a gas generator to the pump inlet to introduce to the liquid flow under pressure;
resupplying liquid flowing from the pump outlet to the pump inlet with a liquid recirculation pipe connecting the pump inlet to the pump outlet;
slanting at least one side of a cylindrical surface of the rotating blades and the fixed blades,
wherein the slant of the cylindrical surface of each of the rotating blades is comprised of a first slanted part in which its surface is slanted against rotation direction of the rotating blade so that it is higher in rotation direction and lower on an opposite side of rotation direction, and
the slant of the cylindrical surface of each of the fixed blades is comprised of a second slanted part in which its surface is slanted against the slant direction of cylindrical surface of the rotating blade so that it is relatively lower on the opposite side of the surface of the first slanted part and higher on its other side,
wherein an eddy booster is formed such that the rotating blade, the fixed blade, and the blade sides of both blades are slanted against a reference radius line.

16. The method for producing nano bubbles with hydroxyl radicals of claim 15, further comprising the steps of:
mixing the liquid under pressure so as to produce cavitation and produce nano bubbles containing ozone gas;
wherein the ozone gas in the nano bubbles reacts with the liquid to produce hydroxyl radicals.

17. The method for producing nano bubbles with hydroxyl radicals of claim 16, further comprising the step of exposing a target material to the hydroxyl radical containing liquid to thereby treat the target material by destroying or neutralizing a contaminant in the target material.

18. The method for producing nano bubbles with hydroxyl radicals of claim 17, wherein the liquid and the target material comprise water.

19. A nano bubble generating system, comprising:
a nano bubble generator comprising a set of interlacing small teeth and large teeth, wherein the small teeth and large teeth are repeatedly rotated and arranged at high speed to propel and pressurize a liquid flowing into and through the system;
a gas generator selectively infusing generated oxygen into the liquid, or into an ozone generator, or into both the liquid and the ozone generator;
the ozone generator selectively infusing generated ozone into the liquid;
the nano bubble generator rotating the liquid under pressure within the interlaced small teeth and large teeth at sufficiently high enough speed to cause internal pressure cavitation and vitalize the liquid with nano bubbles comprised of infused oxygen and/or ozone; and
ejecting the nano bubble infused liquid from the nano bubble generator.

20. The nano bubble generating system of claim 19, further comprising:
a pump propelling a liquid flow through a pump inlet coupled to a pump outlet;
rotating blades coupled to a drive motor and constructed with a lamination of several blades of the large teeth and the small teeth;
fixed blades installed along an inner wall of the pump and constructed with a lamination of several blades of the large teeth and the small teeth conjoined by insertion at a certain distance corresponding to the large teeth and the small teeth of the rotating blades;
multiple impellers installed in a rotation axis to propel liquid through the pump, and placed proximate to the pump inlet prior to the rotating blades and the fixed blades; and
multiple chambers positioned between the multiple impellers to transport liquid through the pump, the liquid propelled by the multiple impellers to pass into and out of the multiple chambers.

21. The nano bubble generating system of claim 19, further comprising:
a pump propelling the rotating liquid cavitating under pressure, the cavitating caused by the interlaced rotating blades and fixed blades; and
wherein at least one side of a formed cylindrical surface of each of the rotating blades and of the fixed blades are slanted.

22. The nano bubble generating system of claim 21, wherein
the slant of cylindrical surface of each of the rotating blades is comprised of a first slanted part in which its surface is slanted against rotation direction of the rotating blade so that it is higher in rotation direction and lower on an opposite side of rotation direction, and
the slant of cylindrical surface of each of the fixed blades is comprised of a second slanted part in which its surface is slanted against the slant direction of the cylindrical surface of each of the rotating blades so that it is relatively lower on the opposite side of the surface of the first slanted part and higher on its other side,
wherein an eddy booster is formed such that the rotating blade, the fixed blade, and the blade sides of both blades are slanted against a reference radius line.

23. The nano bubble generating system of claim 20, further comprising:
a bulkhead installed at the pump outlet to enhance production of the nano bubbles by inducing a pressure change in the liquid exiting the pump outlet;
wherein the bulkhead comprises a bulkhead structure placed in the pump outlet having multiple small diameter partitions at the bulkhead, and an expanded large partition that is connected to the small diameter partitions.

24. The nano bubble generating system of claim 23, further comprising multiple bulkheads separated from each other to form a space there between.

25. The nano bubble generating system of claim 19, wherein the nano bubbles produced contain ozone gas, wherein the ozone gas undergoes a chemical reaction with the liquid to produce hydroxyl radicals.

26. The nano bubble generating system of claim 25, wherein the liquid comprises water.

27. The nano bubble generating system of claim 25, wherein the generated nano bubbles and hydroxyl radicals are used to treat water in a water treatment system, and further comprises:
multiple ones of water tanks connected and arranged in a linear row, wherein each water tank is divided by partitions having have holes to transport and/or discharge processed water from the each water tank;
wherein each of the water tanks comprises a processing compartment for inflowing water and a storage compartment for processed water, wherein water flows from the processing compartment to the storage compartment; and
a transfer pipe connected to the pump outlet and a collection pipe connected to the pump inlet, wherein the processing compartment receives inflowing water with nano bubbles from the transfer pipe and the collection pipe collects processed water outflowing from the storage compartment;
the processing compartment of a front-line water tank including a pipe is connected through a water inlet to supply original contaminated water to the front-line water tank to flow from the water tank to a next water tank in the row;
wherein the processing compartment for inflowing water and the storage compartment for processed water are constructed so that processed water can flow from the processing compartment to the storage compartment through a hole in the partition that divides the two compartments;
a stopping plate causing produced nano bubbles to collide and which is located between the hole in the partition and the end of the transfer pipe installed in the processing compartment; and
a discharge outlet at a final water tank for discharging treated water from the treatment system.

28. The nano bubble generating system of claim 27, further comprising a conveyor possessing multiple transfer plates to filter out sludge and contaminants in original contaminated water or inflowing water, which is installed at the upper portion of the processing compartment for inflowing water.
